(19) United States
(12) Patent Application Publication
(10) Pub. No.: US 2004/0234032 A1
(43) Pub. Date: Nov. 25, 2004

(54) Radiography apparatus, radiography method, radiography program, and recording medium

(75) Inventor: Makoto Nokita, Tokyo (JP)

Correspondence Address: Canon U.S.A. Inc., Intellectual Property Department, 15975 Alton Parkway, Irvine, CA, 92618-3731, US

(73) Assignee: Canon Kabushiki Kaisha, Tokyo (JP)

(21) Appl. No.: 10/845,852

(22) Filed: May 14, 2004

(30) Foreign Application Priority Data
May 20, 2003 (JP) 2003-142372

(51) Int. Cl. H05G 1/64

(52) U.S. Cl. 378/98.8

(57) ABSTRACT

A radiography apparatus comprises an X-ray irradiation unit to irradiate an object with radiation, an X-ray detector which converts radiation projection images obtained by transmission through an object into signals and is capable of non-destructive readout of the signals, and an image analyzing unit for analyzing the signals read out by non-destructive readout from the X-ray detector. This allows information relating to the radiation which has been transmitted through an object such as a subject to be quickly comprehended.

### BACKGROUND OF THE INVENTION

1. Field of the Invention

The present invention relates to a radiography apparatus comprising an X-ray detector or the like, a radiography method, a radiography program, and a recording medium.

2. Description of the Related Art

In X-ray imaging, a film/screen system that encloses a film and an intensifying screen in a cassette or an imaging plate inside a cassette which is used for computed radiography is used as an X-ray sensor to acquire an X-ray image of a patient.

X-ray sensors which can convert an X-ray image directly into digital signals in real time have been proposed in recent years. As this type of X-ray sensor, there is an X-ray detector wherein, for example, a solid-state photo-detector can be manufactured by arraying solid-state photo-detecting devices formed of a transparent conductive film and a conductive film in a matrix format on a substrate formed of quartz glass across from an amorphous semiconductor, and this solid-state photo-detector and a scintillator which converts X-rays into visible light are layered.

The process to acquire a digital X-ray image using this X-ray detector is as follows. First, by irradiating the X-ray detector with an X-ray which has permeated an object, the X-ray is converted to visible light by means of the scintillator. This visible light is then detected as an electric signal by means of the photoelectric conversion unit of the solid-state photo-detecting device. This electric signal is read out according to a predetermined readout method from each solid-state photo-detecting device, and subjected to A/D conversion, whereby an X-ray image signal is obtained.

The description of this type of X-ray detector is described in Japanese Patent Laid-Open No. 8-116044. Additionally, many X-ray detectors have been proposed wherein the X-ray is directly acquired with a solid-state photo-detector without the use of a scintillator.

Because these X-ray detectors detect the strength of an X-ray as the amount of charge, in order to accurately accumulate the X-ray image signal and acquire the X-ray image, driving with a fixed cycle is necessary, such as reading the charge within the pixel, discharging the charge within the pixel, resetting the potential within the pixel, accumulating charge for accumulating X-ray signals, reading the charge within the pixel, and so on.

Recently, X-ray detectors have been developed wherein the above-described X-ray detector driving cycle can be repeated more than ten times per second, and image-taking devices are also being developed that can acquire an X-ray digital image as a moving image.

An X-ray image has a wide concentration distribution, extremely dependent on the amount of X-ray, from the dark areas to the light areas. Therefore, a problem exists in that time is required to perform sufficient image processing and so forth of the areas of interest, and to display and observe the acquired X-ray digital moving image, so X-ray transparent images and X-ray still images cannot be obtained quickly.

In addition, in the case of acquiring the above-described X-ray digital image, in the event that a greater amount of X-ray than necessary is irradiated while observing areas of interest, control during X-ray irradiation becomes necessary to reduce the output of the X-ray generation device, in order to reduce the amount of radiation exposure.

Further, control of the detector becomes necessary, such as finishing the accumulation before the pixel of the X-ray detector of the regions of interest become saturated, or starting the readout of charge signals immediately after X-ray irradiation is completed.

### SUMMARY OF THE INVENTION

The present invention has been made in light of the above problems, and accordingly, it is an object thereof to provide a radiography apparatus, a radiography method, a radiography program, and a recording medium, whereby information relating to radiation permeated through objects such as a subject can be analyzed and the radiography apparatus can be speedily controlled.

According to a first aspect of the present invention, the foregoing problem is solved by a radiography apparatus comprising: a radiation irradiation unit for irradiating radiation; a radiographing unit, configured of a group of multiple imaging elements for converting the radiation into image data; a calculating unit for calculating statistics from the image data; and a control unit for controlling the driving state of the radiation irradiation unit or radiographing unit, based on the statistics.

Other aspects of the present invention provide a radiography method, a radiography program, and a recording medium, each corresponding to the first aspect.

According to the present invention configured thus, information relating to radiation which has passed through objects such as test subjects can be analyzed, and the radiography apparatus can be quickly controlled.

Further features and advantages of the present invention will become apparent from the following description of the preferred embodiments with reference to the attached drawings.

### BRIEF DESCRIPTION OF THE DRAWINGS

FIG. 1 is a block diagram illustrating the configuration of an X-ray radiography device according to the first embodiment of the present invention.

FIG. 2 is a schematic diagram of the configuration of an X-ray detector 110 according to the first embodiment.

FIG. 3 is a circuit diagram illustrating the configuration of a pixel 201 to be placed at row n and column m according to a second embodiment of the present invention.

FIG. 4 is a circuit diagram illustrating the configuration of the pixel 201 to be placed at row n and column m according to the second embodiment of the present invention.

FIG. 5 is a timing chart illustrating the operations of an X-ray radiography device according to a third embodiment of the present invention.

FIG. 6 is a block diagram illustrating the configuration of image analyzing means 125.

FIG. 7 is a circuit diagram illustrating an example of an X-ray detector 110 possessing a non-destructive readout function and a destructive readout function, according to a fourth embodiment of the present invention.

FIG. 8 is a circuit diagram illustrating an example of an X-ray detector 110 possessing a non-destructive readout function and a destructive readout function, according to a fifth embodiment of the present invention.

FIG. 9 is a schematic diagram of the configuration of the X-ray detector 110, according to a sixth embodiment of the present invention.

FIG. 10 is a circuit diagram illustrating an example of the X-ray detector 110 possessing a non-destructive readout function and a destructive readout function, according to the sixth embodiment of the present invention.

FIG. 11 is a flowchart illustrating the flow of operations of the X-ray radiography device of the present invention.

### DESCRIPTION OF THE PREFERRED EMBODIMENTS

Preferred embodiments of the present invention are described in detail below with reference to the drawings. It should be noted that the relative arrangement of the components, the numerical expression and numeral values set forth in these embodiments do not limit the scope of the present invention unless specifically stated otherwise.

The X-ray imaging apparatus (radiography device), the X-ray imaging method (radiography method), the X-ray imaging program (radiography program), and the recording medium according to embodiments of the present invention are described in detail next with reference to the attached drawings.

First Embodiment

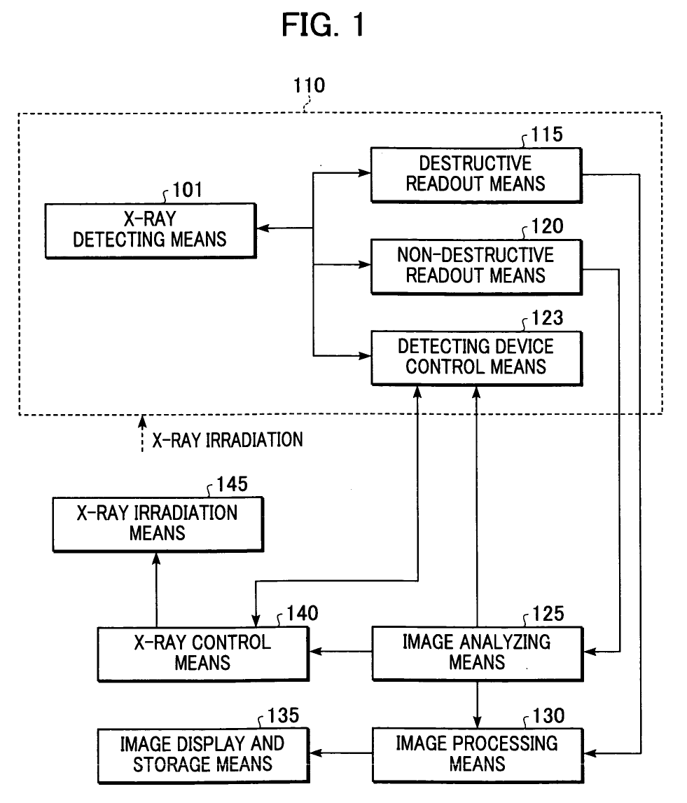

The first embodiment according to the present invention is described next. FIG. 1 is a block diagram illustrating the configuration of an X-ray radiography device, according to the first embodiment of the present invention.

This X-ray imaging apparatus includes an X-ray detecting device (radiography means) 110 capable of non-destructive readout. The X-ray detecting device (X-ray detector) comprises X-ray detecting means 101, destructive readout means 115, non-destructive readout means 120, and detecting device control means 123. The X-ray imaging apparatus also includes image analyzing means 125, image processing means 130, image displaying and storing means 135, X-ray control means 140, and X-ray irradiation means (radiation irradiating means) 145. With regard to readout methods of charge signals accumulated within the pixel provided in the X-ray detector, a readout wherein the accumulation condition of the charge signal does not change is referred to herein as “non-destructive readout,” and a readout wherein the accumulation condition changes or is changed is referred to herein as “destructive readout.” Further, as described in detail later, the X-ray detector 110 is configured so as to convert the X-ray image into digital signals in real time.

Here, the destructive readout means 115, the non-destructive readout means 120, the detecting device control means 123, the image analyzing means 125, the image processing means 130, and the X-ray control means 140 may be configured of an information processing device, for example, a computer, which is capable of executing the X-ray imaging program. According to an embodiment, this X-ray imaging program is configured so that the processing by the destructive readout means 115, the non-destructive readout means 120, the detecting device control means 123, the image analyzing means 125, the image processing means 130, and the X-ray control means 140, is executed on the aforementioned information processing device in accordance with the following description.

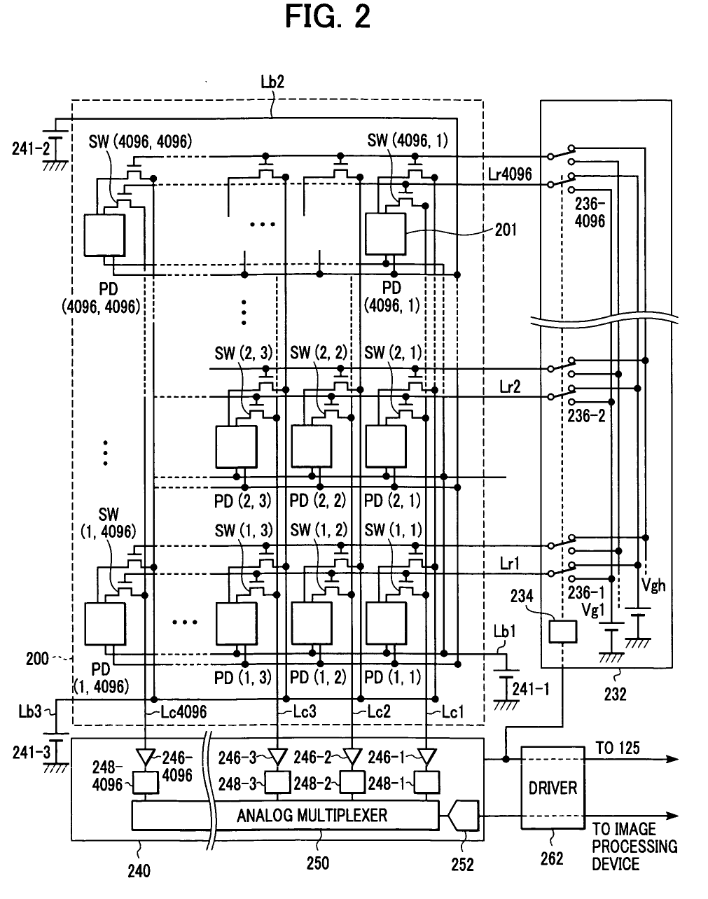

FIG. 2 is a schematic diagram of the configuration of the X-ray detector 110. The X-ray detector 110 may be either a type that directly detects X-rays, or a type that converts X-rays into visible light using a fluorescent member and detects the visible light. Either one is configured so that the pixels to detect the signals are combined in an array, thereby making up a detector array 200. Further, a line selector 232, a signal readout circuit 240, and a drive unit 262 are provided in the X-ray detector 110.

Pixels 201 are arranged within the detector array 200. For example, the detector array 200 may include an arrangement of 4096×4096 pixels 201. Each pixel 201 comprises a signal detecting portion to detect one X-ray or light signal and, a switching TFT to switch between signal accumulation and readout.

For example, photoelectric conversion elements (photodiodes) PD (1, 1) to PD (4096, 4096) are provided as signal detecting portions. Further, switches SW (1, 1) to SW (4096, 4096) are provided as switching TFTs. In FIG. 2, the pixel located at row n and column m is expressed as photodiode PD (n, m), switch SW (n, m). Each photodiode PD (n, m) is provided with a gate electrode and a common electrode, and the accumulation and discharge of charge is performed by applying a different voltage to each electrode.

Within the X-ray detector 110, for each column, a column signal line Lcm (1≦m≦4096) is provided, and for each row, a row selection line Lrn (1≦n≦4096) is provided. The row selection line is comprised of for example one pair of signal lines. Further, lines Lb1 through Lb3 is provided, and the lines Lb1 through Lb3 are connected to common potential 241-1, 241-2, and 241-3, respectively. The gate of each pixel is connected to the column signal line Lcm and line Lb3 via one pair of corresponding switches SW (n, m), and the control terminal is connected to the row selection line Lrn.

The row selection lines Lr1 to Lr4096 are connected to the line selector 232, which selects the row from which the signal charge of the pixel will be read out. An address decoder 234, which decodes the control signal from the detecting device control means 123 and determines the line from which the signal charge of the photodiode PD (n, m) should be read out, is provided in the line selector 232. Further, one pair of switch elements 236-n, which opens and closes according to the output of the address decoder 234, is connected between the power source Vgh and Vg1 and the row selection lines Lr1 through Lr4096.

Within the signal readout circuit 240 which reads out the signal charge of a pixel 201, a sample hold circuit 248-m is provided, which holds the sample output of the amplifier 246-m which amplifies the signal potential from the column signal line Lcm, for each column signal line Lcm.

Within the signal readout circuit 240 is further provided an analog multiplexer 250 that multiplexes the output of the sample hold circuit 248 on a time axis, and an A/D converter 252 that digitizes the analog output of analog multiplexer 250. Driver 262 drives the X-ray detector 110.

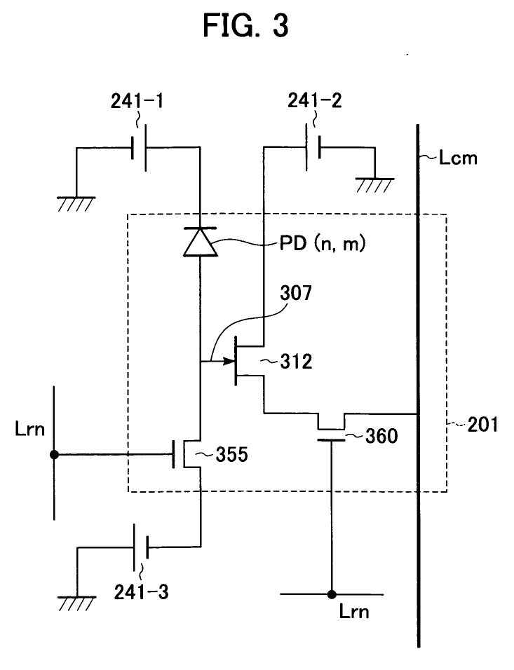

FIG. 3 is a circuit diagram illustrating the configuration of the pixel 201 to be placed at row n and column m, according to the first embodiment of the present invention. Within the pixel 201 is provided the photodiode PD (n, m) that accumulates the light of a fluorescent member which has absorbed X-rays as a signal charge, an accumulated charge holding portion 307 that holds the accumulated signal charge, an amplifying device 312 that amplifies the held signal charge, a reset switch 355, and a readout 360. On/off of the reset switch 355 and the readout switch 360 is controlled by the row selection line Lrn. The reset switch 355 corresponds to the switch SW (n, m) which is connected to the line Lb3 shown in FIG. 2, and the readout switch 360 corresponds to the SW (n, m) which is connected to the column signal line Lcm in FIG. 2.

Bias voltage is applied to the photodiode PD (n, m) from the common potential 241-1. Voltage is applied to the amplifying device 312 from the common potential 241-2. Voltage for resetting the signal charge stored in the accumulated charge holding portion 307 is applied to the accumulated charge holding portion 307 via the reset switch 355, from the common potential 241-3.

The charge generated at the photodiode PD (n, m) by means of X-ray irradiation and held in the accumulated charge holding portion 307 is amplified by the amplifying device 312, and transferred via the readout switch 360 to the column signal line Lcm. Next, the signal transferred to the column signal line Lcm is transferred to the signal readout circuit 240.

Regarding the pixel 201 configured in this manner, the potential Vgh is applied to the reset switch 355 from the row selection line Lrn, and upon the reset switch 355 conducting, the common potential 241-3 is applied to the accumulated charge holding portion 307, and the accumulated charge holding portion 307 is reset.

Following this, the potential Vg1 is applied to the reset switch 355 from the row selection line Lrn, and in the event that the reset switch 355 is closed, the accumulated charge holding portion 307 remains reset in a floating state. In this state, upon X-rays being irradiated upon the photodiode PD (n, m), a signal charge is generated, and is accumulated in the accumulated charge holding portion 307. The potential of the accumulated charge holding portion 307 increases according to the signal charge.

Continuing on, the potential Vgh is applied to the readout switch 360 from the row selection line Lrn, and upon the readout switch 360 conducting, the signal amplified by the amplifying device 312 corresponding to the increased potential is transferred to the column signal line Lcm.

By repeating the above series of operations at the time of the accumulation state of the X-ray detector 110, the signal charge which has been transferred from the photodiode PD (n, m) to the accumulated charge holding portion 307 whenever generated, and accumulated there, can be read out. Further, by viewing the output value of the readout signal, whether an X-ray has begun to enter the X-ray detector 110 and ended, and whether the appropriate X-ray dosage is being irradiated onto the X-ray detector 110, can be detected. Further, the X-ray distribution of the X-ray image to be acquired can be detected before readout from the destructive readout means 115.

In this way, relating to the method of readout wherein the signal charge which has been transferred as it is generated from the photodiode PD (n, m) to the accumulated charge holding portion 307 and accumulation is read out, in the event that the signal charge is reset by turning the reset switch 355 on at the next readout of the signal charge readout, the accumulation state of the signal charge changes. Therefore, this type of readout is a destructive readout.

On the other hand, in the event that the reset switch 355 is not turned on at the next readout of the signal charge readout, and the signal charge is not reset by turning the reset switch 355 on, the accumulation state of the signal charge does not change. Therefore, this type of readout is a non-destructive readout. That is to say, with the present embodiment, the signal charge that is transferred to the accumulated charge holding portion 307 and is accumulated can be read out as it is stored. In other words, the X-ray detector 110 which includes the pixel 201 is configured so as to be capable of destructive readout and non-destructive readout.

Next, the driving methods of the X-ray detector 110, such as the reset of photodiodes, the accumulation of charge, the readout of charge, blank readout, and so forth, will be described, with reference to FIGS. 2 and 3.

First, the driver 262 turns on the reset switches SW (1, 1) through (1, 4096)(reset switch 355 in FIG. 3) connected to the line Lb3, by applying potential Vgh to the row selection line Lr1. As a result, as described above, the common potential 241-3 is applied to the 4096 pixels 201 of the first row, and the charge accumulated in the accumulated charge holding portion 307 is reset.

Next, the driver 262 turns off the reset switches SW (1, 1) through (1, 4096)(reset switch 355 in FIG. 3) connected to the line Lb3, by applying potential Vg1 to the row selection line Lr1. As a result, the common potential 241-1 is applied to the 4096 pixels 201 of the first row. In this state, in the event that a photodiode PD (1, m) is irradiated by an X-ray, a charge is generated proportional to the irradiation amount of the X-ray, and the amount of charge proportional to the shift in potential from the common potential 241-1 is accumulated in the accumulated charge holding portion 307. However, at this time, a dark current excited by temperature other than the X-ray signal flows to the photodiode PD (1, m), and the charge from this dark current is accumulated together with the charge proportional to the amount of X-ray in accumulated charge holding portion 307.

Next, the driver 262 turns on the readout switches SW (1, 1) through (1, 4096)(readout switch 360) connected to the column signal line Lcm, by applying potential Vgh to the row selection line Lr1. As a result, the charge stored in the accumulated charge holding portion 307 is amplified by the amplifying device 312, and then read out from the pixel 201 by the signal readout circuit 240.

The read out signal is amplified by the amplifier 246-m within the signal readout circuit 240. The output signal of the amplifier 246-m is held as a sample in the sample hold circuit 248-m. Subsequently, the output signal of the sample hold circuit 248 is multiplexed by the analog multiplexer 250, relative to a time axis. Next, the analog signal output from the analog multiplexer 250 is converted into a digital signal by the A/D converter 252, and read out.

By repeating this series of operations for all rows 1 through 4096, the accumulation charge of all pixels is read out. Here, resetting the photodiode PD, accumulation of the charge, and readout thereof has been described as a set for each row, but an arrangement may be made wherein after the pixels of all rows 1 through 4096 are reset and placed in an accumulated state one row at a time, and the readout of all pixels 201 from row 1 through 4096 or a portion of the pixels 201 can be performed an optional number of times during the signal charge accumulation.

In order to read out only the accumulated charge proportional to the amount of X-ray, the charge from dark current can be accumulated once again for the same amount of time and be read out, and the difference subtracted. This readout of the charge from the dark current alone is called a blank readout. Or, an arrangement may be made wherein the image from the dark current for a fixed amount of accumulation time is acquired ahead of time, and the dark current components are subtracted from the readout image.

Next, the overview of the operations of an X-ray imaging apparatus configured as described above will be described, with reference to FIG. 1. First, driving of the X-ray detector 110 is started by the detecting device control means 123, and after entering a signal accumulation state from X-ray irradiation, the operator conducts X-ray irradiation using the X-ray irradiation means 145. X-ray irradiation is performed taking into account the timing of driving the X-ray detector 110. The timing of X-ray irradiation may by determined by the operator, or may be controlled by sending the signal of an X-ray irradiation cue from the X-ray control means 140 to the detecting device control means 123, and synchronizing the X-ray irradiation means 145 and driving of the X-ray detector 110.

When X-ray irradiation is performed, a signal charge is accumulated within each pixel of the X-ray detector 110. After the accumulation of the signal charge is completed, or during the accumulation process of the signal charge, the non-destructive readout means 120 controls the driver 262 within the X-ray detector 110 and performs non-destructive readout before the destructive readout by the destructive readout means 115 is performed. Next, the image analyzing means 125 analyzes this X-ray image that has been read out.

As a result, the accumulation state of the accumulated signal charge or the accumulation state of signal charge during accumulation can be comprehended while holding the state of signal charge accumulation. In other words, after completing X-ray irradiation, or during X-ray irradiation, whether the output of X-ray irradiation is/was appropriate, or whether the X-ray irradiation has started or completed, can be determined. Also, whether or not the specified pixels of the areas of interest of X-ray detector 110 have reached accumulative saturation can be determined, and moreover, analysis can be performed on the image currently being acquired to determine what kind of image it is, before the final image is received.

After non-destructive readout is performed by the non-destructive readout means 120, the destructive readout means 115 reads out the X-ray image by destructive readout, then resets the charge or potential for the next accumulation. At this time, part or all of the signal charges accumulated in the pixels drop out due to destructive readout.

Now, the method to use the data obtained by non-destructive readout will be described. Regarding types of analysis of X-ray images by the image analyzing means 125, for example, a histogram analysis of the portion of the body area of interest can be used to display the areas of interest of the subject with appropriate density. Further, in the case of performing enhancing processing and so forth on the image, analysis can be done to specify the regions within the image wherein X-ray quantum noise or noise existing in the X-ray detector 110 itself is conspicuous. However, the present invention is by no means limited to these.

The image analyzing means 125 transmits the results of the X-ray image analysis to the detecting device control means 123, the image processing means 130, and/or the X-ray control means 140. The detecting device control means 123 and the X-ray control means 140 control the X-ray detector 110 and the X-ray irradiation means 145, respectively.

As an example of control of the X-ray detector 110, as in the aforementioned, control may be performed wherein whether or not a pixel within an area of interest of the X-ray detector 110 has reached accumulation saturation, and in the event that there is not saturation, the accumulation state of the X-ray detector 110 is continued, and in the event of approaching saturation, accumulation is immediately terminated, and transition is made to the next driving of the X-ray detector 110. Another example of control is to continue the accumulation state of the X-ray detector 110 in the event that X-ray irradiation has not finished, and in the event that X-ray irradiation has finished to immediately terminate accumulation, and make transition to the next driving of the X-ray detector 110.

As an example of control of the X-ray irradiation means 145, control may be performed wherein, in the event that the accumulation amount of a signal charge is low in a specified pixel of an area of interest of X-ray detector 110, the intensity of X-ray irradiation is increased, following which determination is made as to whether or not accumulative saturation has been reached, and in the event of approaching saturation, X-ray irradiation is immediately terminated.

In a case where the image analysis results are transmitted from the image analyzing means 125 to the image processing means 130, the image processing means 130 performs image processing on the X-ray image obtained by destructive readout by the destructive readout means 115, based on the image analysis results. The processed X-ray image is displayed and/or saved by the image displaying and storing means 135.

Second Embodiment

In the second embodiment, the configuration of the X-ray detector 110 differs from that in the first embodiment. Specifically, each row selection line Lrn is configured from three signal lines, and three transistors are provided within each pixel 201. Further, the switch element 236-n within the line selector 232 is configured so that each row is connected to three signal lines, using the power source Vgh or Vg1 selectively.

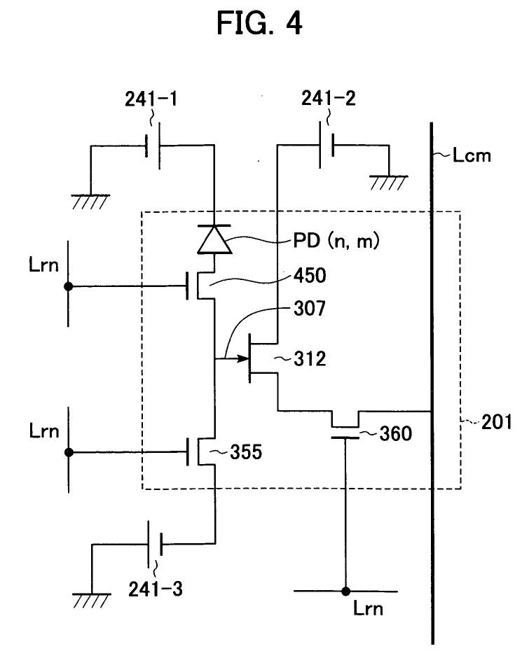

FIG. 4 is a circuit diagram illustrating the configuration of the pixel 201 to be situated at row n and column m, according to the second embodiment of the present invention. The second embodiment comprises the photodiodes PD (n, m), accumulated charge holding portion 307, amplifying device 312, reset switch 355, and readout switch 360 for the pixel 201, as with the first embodiment. Further, a transfer switch 450 is connected between the photodiode PD (n, m) and the accumulated charge holding portion 307. On/off functions for the reset switch 355, the readout switch 360, and the transfer switch 450, are controlled by the row selection line Lrn.

Regarding the pixel 201 configured in this manner, potential Vgh is applied to the reset switch 355 from the row selection line Lrn, and upon the reset switch 355 conducting, common potential 241-3 is applied to the accumulated charge holding portion 307, and the accumulated charge holding portion 307 is reset.

Following this, potential Vg1 is applied to the reset switch 355 from the row selection line Lrn, and in the event that the reset switch 355 is closed, accumulated charge holding portion 307 remains reset in a floating state. In this state, upon an X-ray being irradiated upon the photodiode PD (n, m), a signal charge is formed, and is accumulated when transfer switch 450 has electric conductivity in accumulated charge holding portion 307. The potential of the accumulated charge holding portion 307 then increases corresponding to the signal charge.

Continuing on, potential Vgh is applied to the readout switch 360 from the row selection line Lrn, and upon the readout switch 360 conducting, the signal amplified by amplifying device 312 according to the raised potential is transferred to column signal line Lcm.

By repeating the above series of operations at the time of accumulation state of X-ray detector 110, the signal charge which has been transferred from the photodiode PD (n,

m) to the accumulated charge holding portion 307 whenever generated and accumulated, can be read out. Further, by obtaining the difference in change before and after the readout signal, determination can be made as to whether or not X-ray input to the X-ray detector 110 has started or ended. Further, the irradiation distribution of X-rays into the X-ray detector 110 can be obtained.

Further, with the present embodiment, the saturation threshold value of the signal charge of the accumulated charge holding portion 307 is known in advance, and the signal charge accumulated as necessary and held is detected using the non-destructive readout means 120. At the point that the signal charge of accumulated charge holding portion 307 nears saturation, the potential Vgh is applied from the row selection line Lrn to the transfer switch 450 while the reset switch 455 remains closed, and the transfer switch 450 is closed. As a result, the transfer of accumulated charge to accumulated charge holding portion 307 is stopped while the reset switch 355 remains closed.

Thus, the second embodiment not only includes all of the advantages of the first embodiment, but also allows accumulation to be concluded before the accumulation charge of the accumulated charge holding portion 307 is saturated. This embodiment is also advantageous in that the accumulation time of the signal charges can be made in the same amount of time even in the event that signal charges of a part of the pixels are read by scanning, since all of the transfer switches 450 are opened and closed at the starting and ending time for accumulation. It should be noted however, that there are fewer switches within each pixel 201 than there are in the first embodiment, meaning that the photoreception area of the pixel can be increased to obtain high sensitivity, and also the yield of the X-ray detector 110 is higher with the first embodiment due to the simple structure.

Third Embodiment

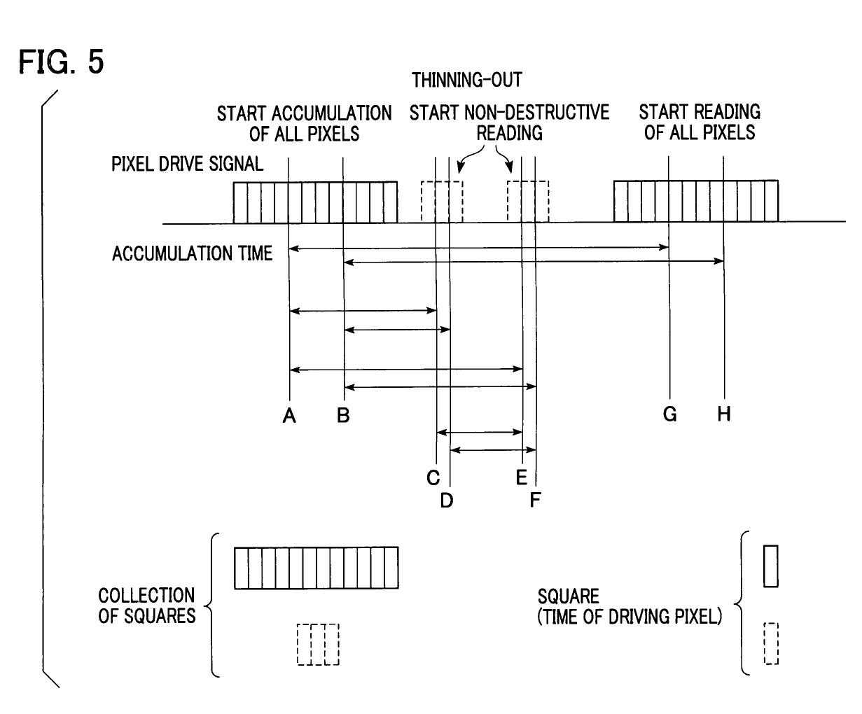

In the third embodiment, the non-destructive readout method using the non-destructive readout means 120 differs from that of the first and second embodiments. Specifically, rather than non-destructive readout being performed from all pixels 201 within the X-ray detector 110, non-destructive readout is performed only from a portion of the pixels 201 by thinning out. FIG. 5 is a timing chart illustrating the operations of an X-ray radiography apparatus according to the third embodiment of the present invention. Note that FIG. 5 illustrates an example wherein the number of all pixels 201 of the X-ray detector 110 is twelve, the number of pixels 201 for thinning out the readout is three, and the number of times that thinning out of the readout is performed is two.

With the present embodiment, like with the first embodiment, the driving of readout and so forth from each pixel 201 is performed using the line selector 232 and the analog multiplexer 250 in time series. Therefore, depending on the location of the pixel 201, the accumulation start time and readout start time of each will differ.

The phrases “Start accumulation of all pixels” and “Start reading of all pixels” in FIG. 5 indicate the time of accumulation start and readout start, respectively, of all pixels 201 of the X-ray detector 110. Further, the two points for “Thinning out, start non-destructive readout” indicate that non-destructive readout with thinning out is performed twice, and also indicate the time that each thinning-out non-destructive read is started. Regarding the collection of squares indicating “Start accumulation of all pixels”, “Start reading of all pixels”, and “Thinning out, start non-destructive readout”, each square represents the driving time of each pixel 201 within the respective collection of squares.

Further, the points in time A, C, E, and G in FIG. 5 denote the points in time of accumulation start, non-destructive readout start, and readout start of the specified pixels which are the object of one of the thinning out non-destructive readouts. Similarly, the points in time B, D, F and H denote the points in time of accumulation start, non-destructive readout start, and readout start of the specified pixels which are the objects of the other thinning out non-destructive readout. Also, times AG and BH denote the two above-described accumulation times, respectively, from the start of pixel accumulation to the start of destructive readout. Times AG and BH are in agreement with one another, but as FIG. 5 illustrates, time AC and time BD, which are the accumulation times from accumulation start to non-destructive readout start, are not in agreement, and also are not in agreement with time AE and time BF. As a result, accumulation time regarding X-ray irradiation or dark current differs, generates shading within the pixels. Therefore, in the present embodiment, in order to perform non-destructive readout by thinning out without shading, thinning out non-destructive readout is performed twice, and the difference between the two is obtained. Since “time CE=time AE−time AC” and “time DF=time BF−time BD” are equal to one another, obtaining the differences as described above does away with the regions of different accumulation times from the image, and shading can be avoided. Irradiating the X-ray before these two thinning out non-destructive readouts enables the accumulation time of the X-ray irradiation to be made to be the same from the difference. Further, irradiating the X-ray after the two thinning out non-destructive readouts enables the accumulation time of the dark current alone to be made the same from the difference. Further, in the event that the frame rate of the former thinning out non-destructive readout is the same as the frame rate of the thinning out non-destructive readout, dark current corrections can be made on the thinning out non-destructive readout image, by subtracting the difference image of the latter from the difference image of the former.

The non-destructive readout means (thinning out readout means) 120 performing this type of thinning out non-destructive readout, means that the time required for non-destructive readout can be shortened compared to the first and second embodiments. Further, the number of pixels to be subjected to thinning out non-destructive readout is not restricted in particular. Moreover, similar effects can be obtained by performing thinning out non-destructive readout in increments of rows.

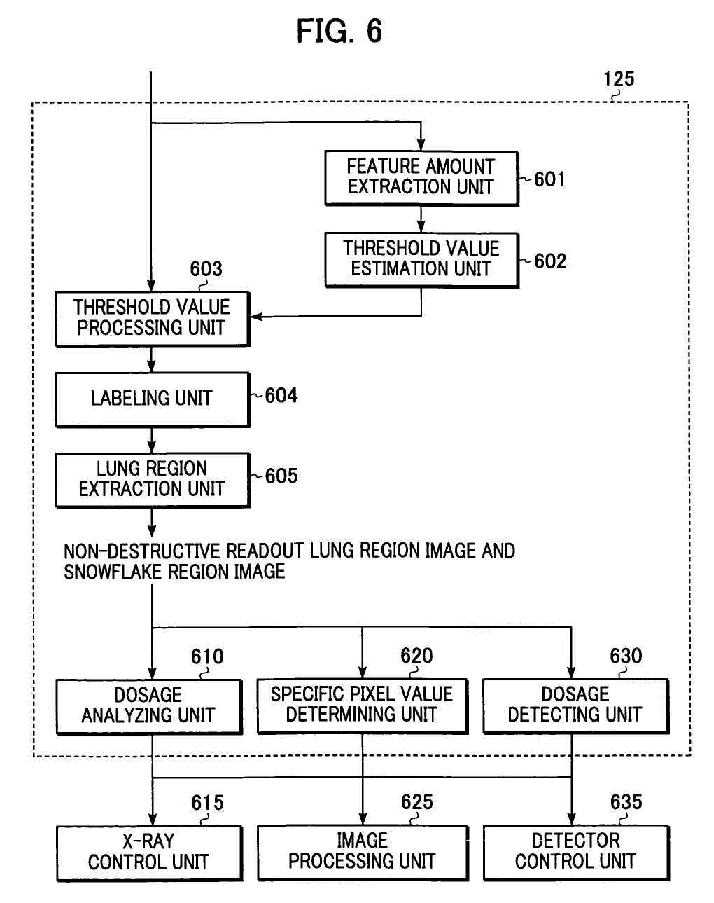

Next, one example of the configuration of image analyzing means 125, the processing executed using this configuration, and the object reflecting the results thereof, will be described, using analysis of the lung region in the X-ray image as an example. FIG. 6 is a diagram illustrating the processing of non-destructive readout X-ray images through the image analyzing means 125, and application of the portion reflecting the processing results. The portion enclosed by the dotted lines corresponds to the image analyzing means 125.

The image analyzing means 125 comprises, for example: a feature amount extraction unit 601; a threshold value estimation unit 602; a threshold value processing unit 603; a labeling unit 604; a lung region extraction unit 605; a dosage analyzing unit 610; an X-ray control unit 615; a specific pixel value determining unit 620; an image processing unit 625; a dosage detecting unit 630; and a detector control unit 635. The feature amount extraction unit 601 acquires the smallest pixel value along the longitude and the largest pixel value within the lung region of the X-ray image using non-destructive readout. The threshold value estimation unit 602 calculates the threshold from the feature amount acquired in the feature amount extraction unit 601. The threshold value processing unit 603 converts the image to binary based on the threshold calculated in the threshold value estimation unit 602. The labeling unit 604 labels the images converted into binary data in the threshold value processing unit 603. The lung region extraction unit 605 takes the images labeled at the labeling unit 604 and erases those regions that touch the edge of the image and represents those regions not erased as lung regions. The dosage analyzing unit 610 determines whether or not sufficient radiation is arriving from the lung region pixel value, and determines whether or not the image of the snowflake region (the portion of the X-ray irradiation region that has no subject) has a sufficient irradiation field. The X-ray control unit 615 performs strength adjustment of the X-ray irradiation amount based on the determination information from the dosage analyzing unit 610, and controls the irradiation field by aperture adjustment. The specific pixel value determining unit 620 specifies the regions of the specified pixel value portion of the lung region image. The image processing unit 625 processes the image concentration (brightness) of the regions specified by specific pixel value determining unit 620 into a specified concentration (brightness). The dosage detecting unit 630 detects to what degree the X-ray irradiation of the accumulation charge amount of the lung region pixel is accumulated. The detector control unit 635 alters the driving of the detector to conclude accumulation at the X-ray detector in the event that, for example, the dosage detecting unit 630 determines that X-ray irradiation has already been concluded, or in the event that the accumulation charge amount has been determined to be close to saturation.

The X-ray control unit 615 is equivalent to the X-ray control means 140 in FIG. 1, the image processing unit 625 is equivalent to the image processing means 130, and the detector control unit 635 is equivalent to the detecting device control means 123.

With the image analyzing means 125 configured as described above, the feature amount extraction unit 601 separates the snowflake region of the irradiation region and the body region in contact with the snowflake region within a fixed space, using a given threshold, and replaces this with zeroes. Next, the largest pixel value is acquired from the image following processing, and the smallest pixel value of the mediastinal space is calculated from the lung region profile from which the largest pixel value is taken, thereby obtaining the aforementioned largest pixel value and the smallest pixel value.

Next, the threshold value estimation unit 602 estimates a threshold, based on the largest pixel value within the lung region and the smallest pixel value amount within the mediastinal space, which have been calculated by the feature amount extraction unit 601. Functions to be used for estimation are, for example, linear regression, neural networks, and so forth, but not be limited to these.

The threshold value processing unit 603 performs threshold processing (such as converting to binary data and so forth) of input images, based on the thresholds calculated by threshold value estimation unit 602.

The labeling unit 604 performs labeling processing of the region of pixel value 1 of the image data which has been converted to binary data at the threshold value estimation unit 602. Here, labeling processing is a process whereby labels are added to distinguish the portions linked by binary conversion.

The lung region extraction unit 605 deletes the areas that are in contact with the edges of the image or that have an area equal to or less than a given value, of the linked regions labeled by the labeling unit 604. As a result of this processing, the remaining region is the lung region. Further, the region connected to the edges of the image is the snowflake region image. In this way, the lung region extraction unit 605 extracts the lung region image and snowflake region image from the non-destructive readout X-ray image by means of the non-destructive readout means 120.

Images extracted from lung region extraction unit 605 are input into the dosage analyzing unit 610, the specific pixel value determining unit 620, and the dosage detecting unit 630.

The dosage analyzing unit 610 uses the greatest pixel value or average pixel value and comprehends the dosage of X-ray from the lung region image, passing through the subject and into X-ray detector 110. This comprehending of the X-ray dosage can be accomplished by acquiring in advance the relationship between, for example, the incident X-ray dosage and the pixel output.

Next, in the event that the X-ray dosage is low for the aforementioned comprehended X-ray dosage, the X-ray control unit 615 controls the X-ray irradiation means 145, such as extending the X-ray irradiation time or raising the X-ray intensity per increment of time.

The specific pixel value determining unit 620 specifies the largest pixel value or the value which is the mean between the largest pixel value and the average pixel value from the lung region image.

Next, the image processing unit 625 performs gradation conversion on the image read out by the destructive readout means 115, so that the density of the aforementioned largest pixel value or the mean (brightness in the case of a monitor) will be the appropriate density (for example, density of 1.7 for a chest area image, and so forth).

The dosage detecting unit 630 detects whether or not there is a pixel within the lung region pixels close to saturation of accumulated charge. Whether or not the accumulated charge is close to saturation can be determined by acquiring in advance an image irradiated by the saturation dosage.

Next, detector control unit 635 performs driving control such as immediately terminating accumulation at the X-ray detector 110 when the accumulated charge is determined to be close to saturation, reading out the X-ray image using destructive readout means 115, and so forth.

As described above, according to the present embodiment, acquiring X-ray images by non-destructive readout during charge accumulation of the X-ray detector 110 and performing X-ray control based on the analysis results from the image analyzing means 125 enables X-ray images to be obtained with the appropriate dosage, so that the dosage of exposure to the subject is suitably small. Further, relating to the controls of X-ray detector 110, loss of X-ray images due to the accumulated charge saturation of pixels can be prevented. Further, relating to image processing, performing image analysis based on X-ray images read out in advance using non-destructive readout allows images from destructive readout to be quickly processed with regard to gradation, and displayed in real time.

Further, in the third embodiment, the difference image of at least two images obtained by non-destructive readout the first input in FIG. 6 as “non-destructive readout X-ray images” are used as necessary, in the case of thinning out non-destructive readout and so forth.

Fourth Embodiment

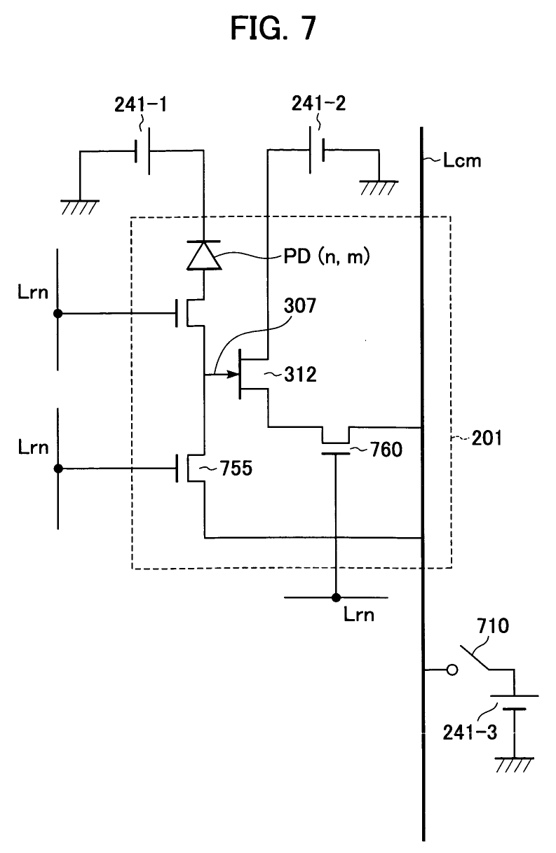

In the fourth embodiment, the configuration of the X-ray detector 110 differs from that in the first and second embodiments. Specifically, the reset switch 355 shown in FIG. 3 also takes on the role of a switch for destructive readout. As illustrated in FIG. 7, with the present embodiment, the output destination of the reset switch (and destructive readout switch) 755 is the same signal line Lcm as the output destination of the non-destructive readout switch 760. Therefore, the third common potential 241-3 for the reset of the accumulated charge of pixels 201 is configured as to connect to the reset switch (and destructive readout switch) 755 via the signal line Lcm. Further, the common potential switch 710 is provided so that the accumulated charge can be reset, and destructive readout can be carried out, using a single signal line Lcm.

FIG. 7 is a circuit diagram illustrating the configuration of a pixel 201 located at row n and column m in the present embodiment. In the present embodiment, as with the first embodiment, the photodiodes PD (n, m), accumulated charge holding portion 307, amplifying device 312, reset switch (and destructive readout switch) 755, and non-destructive readout switch 760 are provided to the pixels 201. On/off functions for the reset switch (and destructive readout switch) 755, the non-destructive readout switch 760, and the transfer switch 450, are controlled by the row selection line Lrn.

Regarding pixels 201 configured in this manner, upon the common potential switch 710 conducting, potential Vgh is applied from the row selection line Lrn to the reset switch (and destructive readout switch) 755, and electricity is passed through the reset switch (and destructive readout switch) 755, the common potential 241-3 is applied to the accumulated charge holding portion 307, and the accumulated charge holding portion 307 is reset.

Following this, potential Vg1 is applied to the reset switch (and destructive readout switch) 755 from the row selection line Lrn, and in the event that the reset switch (and destructive readout switch) 755 is closed, the accumulated charge holding portion 307 remains reset in a floating state. In this state, upon an X-ray being irradiating upon the photodiode PD (n, m), a signal charge is formed, and is accumulated in the accumulated charge holding portion 307. Next, the potential of the accumulated charge holding portion 307 is raised according to the signal charge.

Next, with the common potential switch 710 remaining closed, applying potential Vgh from the row selection line Lrn to the non-destructive readout switch 760 and the non-destructive readout switch 760 conducting, causes the signal amplified by the amplifying device 312 corresponding to the raised potential to be transferred to the column signal line Lcm. The signal charge is read out while holding the charge in the accumulated charge holding portion 307, so this is a non-destructive readout.

By repeating the above series of operations at the time of accumulation state of X-ray detector 110, the signal charge which has been transferred from the photodiode PD (n, m) to the accumulated charge holding portion 307 and accumulated as it is generated, can be read out. Further, by obtaining the change difference of before and after the readout signal, determination can be made as to whether X-ray input to the X-ray detector 110 has started or concluded. Further, using the difference image of two arbitrary images obtained by non-destructive readout enables the irradiation distribution of X-rays to the X-ray detector 110 to be obtained.

On the other hand, with the common potential switch 710 remaining closed, applying potential Vgh from the row selection line Lrn to the non-destructive reset switch (and destructive readout switch) 755 and the reset switch (and destructive readout switch) 755 conducting, causes the potential accumulated in the accumulated charge holding portion 307 to pass through the reset switch (and destructive readout switch) 755, and be output to the signal line Lcm, so that the signal charge is read out. From this readout, a part or all of the potential accumulated in accumulated charge holding portion 307 is erased in one readout. Therefore, this reads out the signal charge without holding the accumulated charge in the accumulated charge holding portion 307, and accordingly is a destructive readout.

After the destructive readout, only a charge that is no longer related to the state after X-ray irradiation dosage, nor related to the state before accumulation, remains in accumulated charge holding portion 307. Therefore, in order to read out a signal charge again which is related to X-ray dosage, it becomes necessary to reset the pixels 201 by applying electricity to the common potential switch 710 while-leaving open the reset switch (and destructive readout switch) 755 which has been used for destructive readout.

Thus, according to the fourth embodiment, advantages are obtained wherein the pixels 201 can be reset at the same time as destructive readout of the signal charge, and the X-ray detector 110 can be driven with optimal efficiency, in addition to the advantages obtained through the first and second embodiments.

Fifth Embodiment

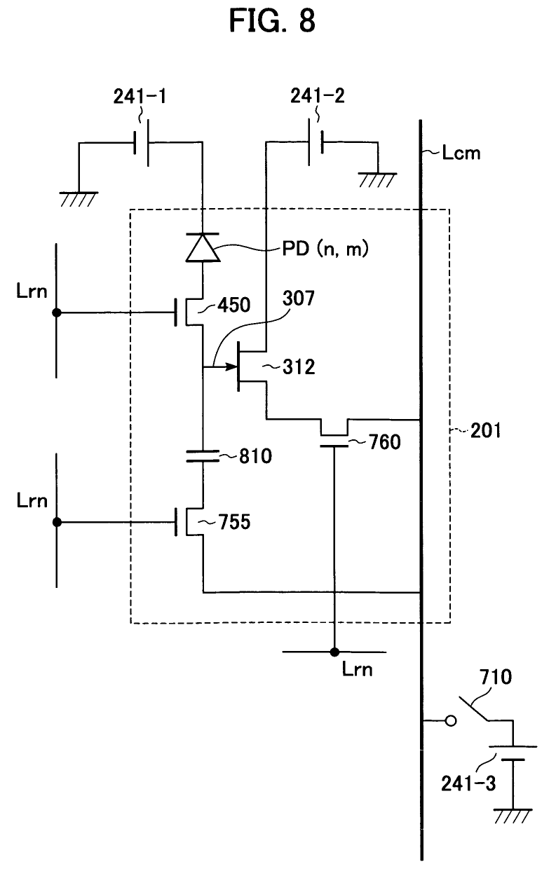

In the fifth embodiment, the configuration of X-ray detector 110 differs from that of the first, second, and fourth embodiments. Specifically, the configuration of destructive readout of pixels 201 differs, and as FIG. 8 illustrates, a capacitor 810 is provided between the reset switch (and destructive readout switch) 755 which was connected to the accumulated charge holding portion 307 in the fourth embodiment, and the accumulated charge holding portion 307.

In this case, the charge held in the accumulated charge holding portion 307 is not discharged from the reset switch (and destructive readout switch) 755 as in the fourth embodiment. Therefore, in order to discharge the charge held in the accumulated charge holding portion 307 towards the side of the first common potential 241-1 through the photodiodes PD, the difference in potential between the first common potential 241-1 and the third common potential 241-3 must be adjusted.

FIG. 8 is a circuit diagram illustrating the configuration of the pixels 201 located at row n and column m, according to the fifth embodiment of the present invention. The present embodiment comprises the photodiodes PD (n, m), accumulated charge holding portion 307, amplifying device 312, reset switch (and destructive readout switch) 755, and non-destructive readout switch 760 for pixel 201, as with the first embodiment. The on/off functions of the reset switch (and destructive readout switch) 755, the non-destructive readout switch 760, and the transfer switch 450 are controlled by the row selector line Lrn.

Regarding pixels 201 configured in this manner, upon the common potential switch 710 conducting, potential Vgh being applied from the row selection line Lrn to the reset switch (and destructive readout switch) 755, and the reset switch (and destructive readout switch) 755 conducting, common potential 241-3 is applied to accumulated charge holding portion 307, and the accumulated charge holding portion 307 is reset. At this time, the potential difference between the first common potential 241-1 and the accumulated charge holding portion 307 is fixed so as to be held in the accumulated charge holding portion 307, but in order to discharge the accumulated potential, the potential difference between the first common potential 241-1 and the accumulated charge holding portion 307 which has conductivity with the third potential 241-3 must be set so as to be inverse to before.

Following this, potential Vg1 is applied to the reset switch (and destructive readout switch) 755 from the row selection line Lrn, and in the event that the reset switch (and destructive readout switch) 755 is closed, the accumulated charge holding portion 307 remains reset in a floating state. In this state, upon an X-ray irradiating the photodiode PD (n, m), a signal charge is formed, and is accumulated in the accumulated charge holding portion 307 and the capacitor 810. The potential of the accumulated charge holding portion 307 then increases corresponding to the signal charge.

Next, with the common potential switch 710 remaining closed, in the event that the potential Vgh is applied from the row selection line Lrn to the non-destructive readout switch 760, and the non-destructive readout switch 760 conducts, the signal amplified by the amplifying device 312 according to the increased potential is transferred to the column signal line Lcm. This reads out the signal charge while holding the charge in the accumulated charge holding portion 307, and therefore is a non-destructive readout.

By repeating the above series of operations at the time of accumulation state of X-ray detector 110, the signal charge which has been transferred from the photodiode PD (n,

m) to the accumulated charge holding portion 307 and accumulated as it is generated, can be read out. Further, by obtaining the change difference of before and after the readout signal, determination can be made as to whether X-ray input to the X-ray detector 110 has started or concluded. Further, using the difference image of two arbitrary images obtained by non-destructive readout, the incident distribution of X-ray to the X-ray detector 110 can be obtained.

On the other hand, with the common potential switch 710 remaining closed, upon potential Vgh being applied from the row selection line Lrn to the non-destructive reset switch (and destructive readout switch) 755, and the reset switch (and destructive readout switch) 755 conducting, the reverse charge corresponding to the accumulated charge of the capacitor 810 which reflects the X-ray dosage flows through the signal line Lcm through the reset switch (and destructive readout switch) 755, and the potential of the signal line Lcm changes in proportion to the X-ray dosage, corresponding to the state before X-ray irradiation. By means of amplifying the difference between this potential before X-ray irradiation and the potential after passing electricity through the reset switch (and destructive readout switch) 755 with the amplifier 246-m or the like, a signal proportionate to the X-ray irradiation dosage can be read out.

There is a high probability that the potential applied to the capacitor 810 will be different before and after passing through the reset switch (and destructive readout switch) 755, and accordingly the amount of accumulated charge in the accumulated charge holding portion 307 also changes. Therefore, this reads out the signal charge without holding the accumulated charge of accumulated charge holding portion 307, and is a destructive readout.

Further, the charge to capacitor 810 is also different before and after passing through the reset switch (and destructive readout switch) 755, and therefore no longer reflects the X-ray dosage read out through the reset switch (and destructive readout switch) 755 from the second time on. Therefore, resetting the pixels 201 for the next readout is necessary.

In the example of this fifth embodiment, destructive readout is the readout of a signal based on potential difference. Therefore, the amplifying device 312 shown in FIG. 8 is an arrangement which amplifies the potential of the accumulated charge holding portion 307. However, in the example of reading out the current to the capacitor 810 at the time of destructive readout, the amplifying device 312 shown in FIG. 8 is an arrangement that amplifies the current to the non-destructive readout switch, corresponding to the potential flowing to the accumulated charge holding portion 307.

Thus, the fifth embodiment is advantageous in that the portion of destructive readout making up the pixels 201 may be a MIS-Type (Reference document: Novel Large Area MIS type X-ray Image Sensor for Radiography, SPIE Vol. 3336 Physics of Medical Imaging (1998)), whereby photodiodes PD and the reset switch (and destructive readout switch) 755 can be formed into the same configuration, and the manufacturing yield of the X-ray detector 110 is high, in addition to the advantages obtained through the fourth embodiment. Further, the portion of destructive readout making up the pixels 201 relating to the fourth embodiment has a PIN-Type configuration, advantageously generally having better sensitivity to X-rays than MIS-Type.

Sixth Embodiment

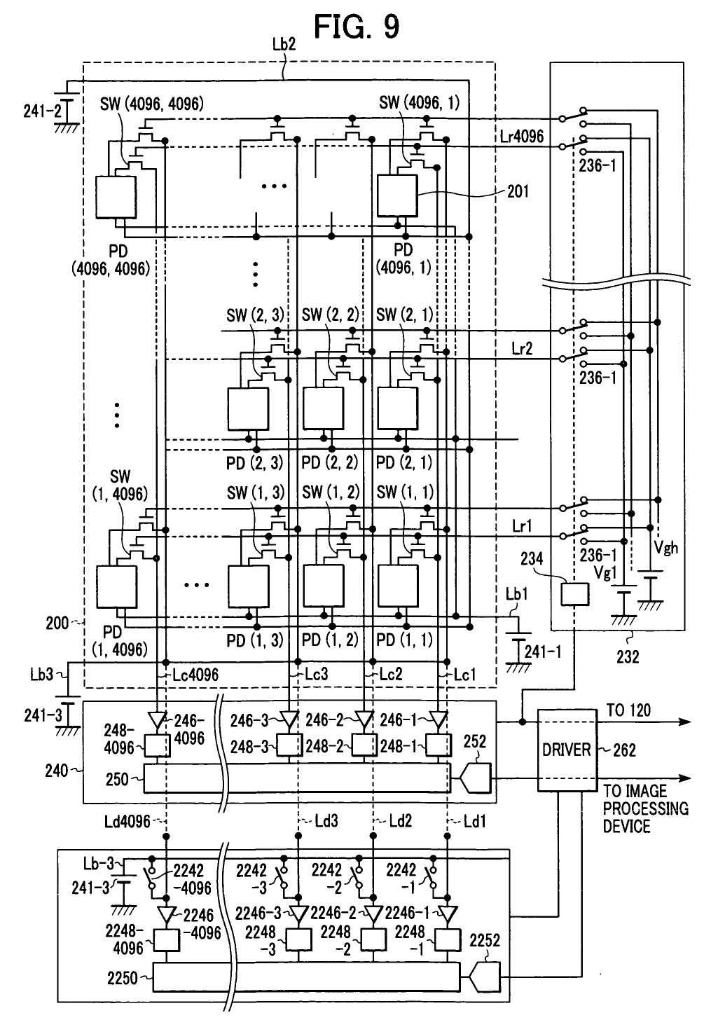

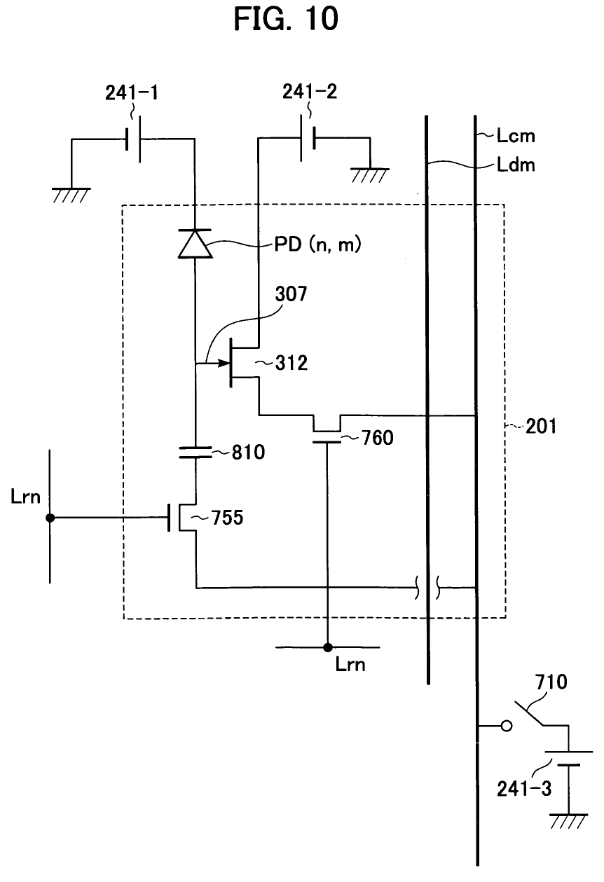

In the sixth embodiment, the configuration of the X-ray detector 110 differs from that of the first, second, fourth, and fifth embodiments. Specifically, the signal of destructive readout from the pixels 201 and the signal of non-destructive read from the pixels 201 have different outputs due to different signal lines. By separating the signal lines for destructive readout and non-destructive readout, amplification and digitizing of each signal can be accomplished appropriately based on each readout method. Therefore, the sixth embodiment provides the amplifier 246-m, sample hold circuit 248-m, analog multiplexer 250, and A/D converter 252, as to each signal line for destructive readout and non-destructive readout, as illustrated in FIGS. 9 and 10.

The sixth embodiment as illustrated in FIGS. 9 and 10, in comparison with FIGS. 2 and 3, is configured so as to separate the signal lines Lcm into signal line Lcm for non-destructive readout and signal line Ldm for destructive readout. To explain the difference between the configuration shown in FIG. 10 and the configuration shown in FIG. 2, the signal from the non-destructive readout switch 760 (of FIG. 10) is output to the signal line Lcm, and the signal from the reset switch (and destructive readout switch) 755 is output to the signal line Ldm. The signal line Ldm is connected to the third common potential 241-3 from line Lb3, via the common potential switch 710 (common potential switch 2242-m in FIG. 9).

Non-destructive readout output from signal line Lcm is amplified at amplifier 246-m, the amplification signal is sample held at the sample hold circuit 248-m, multiplexed on a time axis by the analog multiplexer 250, and becomes a digital image at the A/D converter 252, as with the case in FIG. 2. Destructive readout output from signal line Ldm is amplified at the amplifier 2246-m, the amplification signal is sample held at the sample hold circuit 2248-m, multiplexed on a time axis at the analog multiplexer 2250, and becomes a digital image at the A/D converter 2252.

Resetting the photodiodes PD, accumulation of the potential, and the driving methods of the X-ray detector 110 for charge readout, are described next with reference to FIGS. 9 and 10.

First, by applying potential Vgh to the row selection line Lr1, the driver 262 turns the reset switches (and destructive readout switches) SW (1, 1) through (1, 4096) (the reset switch (and destructive readout switch) 755 in FIG. 10) connected to line Lb3 on, and turns the common potential switch 2242-m (the common potential switch 710 in FIG. 10) on. As a result, common potential 241-3 is applied to the 4096 pixels 201 in the first row, and the charge accumulated in the accumulated charge holding portion 307 is reset.

Next, by applying potential Vg1 to the row selection line Lr1, the driver 262 turns the reset switches (and destructive readout switches) SW (1, 1) through (1, 4096) off. As a result, the common potential 241-1 is applied to the 4096 pixels 201 of the first row. In this state, in the event that the photodiode PD (1, m) is irradiated by an X-ray, a charge is generated proportional to the irradiation amount of the X-ray, and the amount of charge proportional to the shift in potential from the common potential 241-1 is accumulated in the accumulated charge holding portion 307. However, when this happens, a dark current excited by temperature other than the X-ray signal flows to the photodiode PD (1, m), and the charge from this dark current is accumulated together with the charge proportional to the amount of X-ray in the accumulated charge holding portion 307.

Next, the driver 262 is turned on using the non-destructive readout switches SW (1, 1) through (1, 4096) (non-destructive readout switch 760) connected to the column signal line Lcm, by applying potential Vgh to the row selection line Lr1. As a result, the charge held in accumulated charge holding portion 307 is amplified by the amplifying device 312, and then read out from pixel 201 by means of signal readout circuit 240.

The read out signal is amplified by the amplifier 246-m in the signal readout circuit 240. The output signal of the amplifier 246-m is held as a sample in the sample hold circuit 248-m. After this, the output signal of the sample hold circuit 248 is multiplexed by the analog multiplexer 250 relative to a time base. Next, the analog signal output from the analog multiplexer 250 is converted by the A/D converter 252 and read out as a digital signal.

By repeating this series of operations for all rows 1 through 4096, the accumulation charge of all pixels is read out by non-destructive readout. Here, resetting the photodiode PD, the accumulation of the charge, and non-destructive readout, have been described as a set for each row, but an arrangement may be made wherein after the pixels of all rows 1 through 4096 are reset and placed in an accumulated state one row at a time, and the readout of all pixels 201 from row 1 through 4096 or a portion of the pixels 201 can be performed an optional number of times during the signal charge accumulation.

After X-ray irradiation is finished, the driver 262 applies potential Vgh to the row selection line Lr1 to turn on the reset switches (and destructive readout switches) SW (1, 1) through (1, 4096) (reset switch (and destructive readout switch) 755), connected to the column signal line Ldm, while the common potential switch remains off. As a result, a signal proportional to the accumulated charge, accumulated in the accumulated charge holding portion 307 and the capacitor 810, is read out by destructive readout. As a result of this readout, the state of the accumulated charge holding portion 307 and the capacitor 810 changes.

Immediately following destructive readout, turning on the common potential switch while the reset switches (and destructive readout switches) SW (1, 1) through (1, 4096) (reset switch (and destructive readout switch) 755) are on, the first row of pixels 201 is reset.

While description has been made regarding resetting at the same time as readout, an arrangement may be made where destructive readout of the pixels 201 of all rows is carried out without resetting the first row of pixels 201.

Repeating this series of actions for all rows 1 through 4096 enables destructive readout for the accumulated charge of all pixels. Making the reset at the time of destructive readout and the above-described reset before accumulation to be the same is also advantageous in that the frame rate of destructive readout can be increased.

Due to separating the output of non-destructive readout and the output of destructive readout in this manner, each respective signal can be appropriately amplified, sampled, and digitized. For example, regarding non-destructive readout, the output image is used for: control the X-ray irradiation means 145, control of the X-ray detector 110, analysis for image processing, observation of the movements of the subject, and so forth. Accordingly, real time processing is required. There is the advantage here of maximizing performance of the signal readout circuit 240 to perform processing with a high frame rate such as that of a moving image. Further, regarding destructive readout, the output image requires image properties having a high signal-to-noise ratio (SNR), such as in primarily static images, or a wide dynamic range for detecting large X-ray dosages. There is the advantage here of maximizing performance of the signal readout circuit 2240 so as to be suitable to the configuration of destructive readout.

With the first and second embodiments, non-destructive readout and destructive readout were distinguished using driving control of a detector, but the fourth through sixth embodiments have been described with reference to an example wherein physical distinction is made between non-destructive readout and destructive readout.

Seventh Embodiment

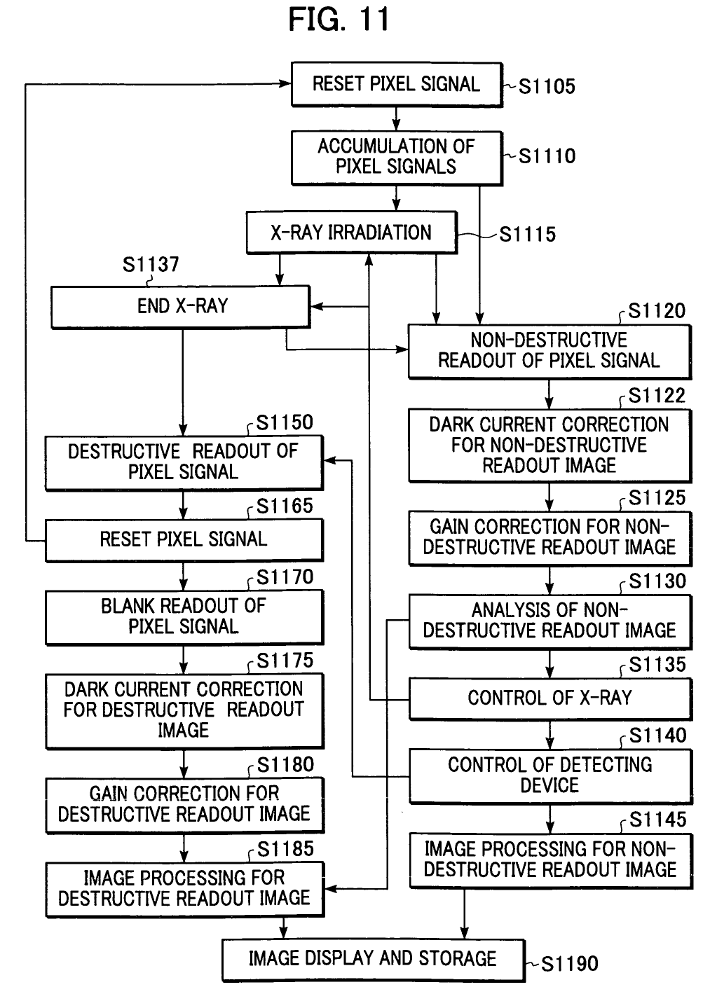

The description of the seventh embodiment describes the operations of the X-ray imaging apparatus of the present invention. FIG. 11 is a flowchart illustrating the operations of the X-ray imaging apparatus relating to the seventh embodiment of the present invention. First, upon the operator transmitting an X-ray irradiation signal, the X-ray detector 110 resets the pixels (step S1105), and begins the accumulation of pixel signals (S1110). Immediately following the start of accumulation, non-destructive readout of pixel signals begins in step S1120. Upon accumulation beginning, X-rays are irradiated from the X-ray irradiation means 145. The timing of X-ray irradiation can be as soon as accumulation starts, or can be controlled in step S1135. During X-ray irradiation, non-destructive readout is repeated in step S1120. In the event that non-destructive readout is a thinning-out readout, the difference image of two non-destructive readout images is acquired.

After performing dark current correction (step S1122) and gain correction of several pixels (step S1125), the image read out using non-destructive readout is subjected to analysis of the image readout using non-destructive readout (step S1130). The image for dark current correction can be obtained from the difference of the images read out twice using non-destructive readout before imaging. Further, this can be acquired in advance, prior to imaging. Moreover, acquiring the image for gain correction in advance is preferable.

In the event that the X-ray dosage is not appropriate after the analysis results of non-destructive readout images, X-ray control is performed in step S1135. Based on the analysis results of non-destructive readout images, in step S1140, the X-ray detector 110 is left in the accumulation state while X-ray irradiation continues. Further, in the event that X-ray irradiation has ended, destructive readout quickly begins in step S1150.

In step S1165, the pixel signal is reset simultaneously with destructive readout. In the case that imaging is to be continued, this reset is the same as the reset in step S1105.

After destructive readout and the reset of pixel signals are concluded, the blank readout of pixel signals begins in step S1170. In step S1175, dark current correction of destructive readout images is performed, using the destructive readout image and blank readout image. Further, after dark current correction, gain correction of the respective pixels is performed in step S1180.

In step 1185, based on the analysis results of step S1130, image processing of destructive readout image is performed on the destructive readout image after dark current correction (step S1175) and gain correction (step S1180) have been performed. The image following image processing (of step S1185) undergoes image display or storage in step S1190. Further, the image display or storage in step S1190 is not limited to an image from destructive readout, but may be performed on non-destructive readout images as well. In that case, image processing of non-destructive readout images is performed in step S1145, and image display or storage is performed in step S1190.

As described above, the embodiments of the present invention can be realized by a computer executing a program. Further, the means for providing a program to a computer, for example, a computer-readable recording medium such as a CD-ROM (compact disc read-only memory) or the like storing a program, or a transmission medium for transferring programs such as the Internet, can be applied as embodiments of the present invention. The program, recording medium, transmission medium, and program product, are encompassed by the present invention.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A radiography apparatus comprising:
a radiation irradiation unit;
a radiographing unit comprising a group of multiple imaging elements, the radiographing unit configured to convert the radiation irradiated by the radiation irradiation unit into image data;
a calculating unit configured to calculate statistics from the image data; and
a control unit configured to control the driving state of said radiation irradiation unit or radiographing unit, based on the statistics.

2. The radiography apparatus according to claim 1, further comprising a region determination unit configured to determine a region from the image data, wherein said calculating unit calculates statistics from image data within the region.

3. The radiography apparatus according to claim 2, wherein said region determination unit extracts a subject as the region from within the images.

4. The radiography apparatus according to claim 3, wherein the subject can be extracted by deleting direct radiation regions.

5. The radiography apparatus according to claim 4, wherein said calculating unit calculates a largest value and a mean as statistics.

6. The radiography apparatus according to claim 4, wherein said calculating unit calculates statistics based on a histogram.

7. The radiography apparatus according to claim 3, wherein said calculating unit calculates a largest value and a mean as statistics.

8. The radiography apparatus according to claim 3, wherein said calculating unit calculates statistics based on a histogram.

9. The radiography apparatus according to claim 2, wherein said calculating unit calculates a largest value and a mean as statistics.

10. The radiography apparatus according to claim 2, wherein said calculating unit calculates statistics based on a histogram.

11. The radiography apparatus according to claim 1, wherein said calculating unit calculates a largest value and a mean as statistics.

12. The radiography apparatus according to claim 1, wherein said calculating unit calculates statistics based on a histogram.

13. The radiography apparatus according to claim 1, wherein said control unit stops charge accumulation of a group of imaging elements of said radiographing unit when the statistics are higher than a predetermined value.

14. The radiography apparatus according to claim 1, wherein said control unit stops radiation of said radiation irradiation unit, when the statistics are higher than a predetermined value.

15. The radiography apparatus according to claim 1, further comprising an image processing unit configured to change image processing methods based on the statistics.

16. A radiography apparatus comprising:
an X-ray irradiation unit configured to irradiate an object with radiation;
an X-ray detector configured to convert radiation projection images obtained by transmission through an object into signals and to perform non-destructive readout of the signals; and
an image analyzing unit configured to analyze the signals read out by the non-destructive readout from the X-ray detector.

17. A radiography method, comprising:
irradiating radiation, the radiation irradiated by a radiation irradiation unit;
converting the radiation into image data, said converting being performed by a radiography unit;
calculating statistics from the image data, and;
controlling a driving state of the radiation irradiation unit or the radiography unit based on the statistics.

18. A radiography program which causes a computer to execute steps of:
irradiating radiation, the radiation irradiated by a radiation irradiation unit;
converting the radiation into image data, said converting being performed by a radiography unit;
calculating statistics from the image data, and;
controlling a driving state of the radiation irradiation unit or the radiography unit based on the statistics.

19. A computer-readable recording medium which stores a radiography program which causes a computer to execute steps of:
irradiating radiation, the radiation irradiated by a radiation irradiation unit;
converting the radiation into image data, said converting being performed by a radiography unit;
calculating statistics from the image data, and;
controlling a driving state of the radiation irradiation unit or the radiography unit based on the statistics.
